(19) United States
(12) Patent Application Publication
(10) Pub. No.: US 2020/0185735 A1
(43) Pub. Date: Jun. 11, 2020

(54) SYSTEM AND METHOD OF CONTROLLING OPERATION OF FUEL CELL

(71) Applicants: Hyundai Motor Company, Seoul (KR); Kia Motors Corporation, Seoul (KR)

(72) Inventors: Dae Jong Kim, Yongin (KR); Hyun Suk Choo, Seongnam (KR)

(21) Appl. No.: 16/418,000

(22) Filed: May 21, 2019

(30) Foreign Application Priority Data
Dec. 6, 2018 (KR) 10-2018-0156327

(51) Int. Cl. H01M 8/04858; H01M 8/04537; H01M 8/04828; H01M 16/00; B60L 50/75

(52) U.S. Cl. CPC H01M 8/0488; H01M 8/0491; H01M 8/04559; H01M 2250/20; H01M 16/006; B60L 50/75; H01M 8/0494

(57) ABSTRACT

An operation control system of a fuel cell is provided. The system includes a fuel cell stack and a motor connected to the fuel cell stack via a main bus end to receive power. A booster is disposed between a load and the fuel cell stack of the main bus end to adjust an output voltage of the fuel cell stack. A high-voltage battery is connected between a load and the booster of the main bus end and a voltage sensor is connected between the booster and the fuel cell stack of the main bus end to measure an output voltage of the fuel cell stack.

### CROSS REFERENCE TO RELATED APPLICATION

The present application claims priority to Korean Patent Application No. 10-2018-0156327, filed on Dec. 6, 2018, the entire contents of which is incorporated herein for all purposes by this reference.

### BACKGROUND

### 1. Technical Field

The present disclosure relates to a system and method of controlling an operation of a fuel cell, and more particularly, to a technology for adjusting the voltage of a fuel cell stack to enhance durability.

### 2. Description of the Related Art

A fuel cell converts chemical energy into electric energy using an oxidation-reduction reaction of hydrogen and oxygen, supplied from a hydrogen supply device and an air supply device, respectively. The fuel cell includes a fuel cell stack that generates electric energy, a cooling system that cools the fuel cell stack, and the like. In other words, hydrogen is supplied to an anode of a fuel cell stack, an oxidation reaction of hydrogen proceeds to generate hydrogen ions (proton) and electrons in the anode. The generated hydrogen ions and electrons are moved to the cathode through an electrolyte membrane and a separator, respectively. In the cathode, water is generated through an electrochemical reaction in which the hydrogen ions and the electrons that arc moved from the anode and oxygen in the air participate, and electric energy is generated from the flow of the electrons.

When a fuel cell stack is exposed to a high voltage close to an open circuit voltage (OCV), the durability thereof is degraded due to a problem such as damage to a catalyst within the fuel cell stack. In general, a fuel cell-battery hybrid type device that uses both a fuel cell and a high-voltage battery, which is charged with power output from the fuel cell and is discharged, uses a high-voltage battery with low capacitance due to limitations of space, weight, and the like, and accordingly, the fuel cell provides most of the power required by a motor. In particular, the high-voltage battery has a maximum chargeable or dischargeable output that has a much lower level than the maximum output of the fuel cell, and is mainly used to supplement output when a fuel cell vehicle accelerates or to recover regenerative brake energy when the vehicle brakes.

Accordingly, when an upper voltage limit of the fuel cell stack is limited, there is a limit in charging the high-voltage battery with surplus output of the fuel cell stack, and thus there is a limit in controlling the upper voltage limit of the fuel cell stack. In addition, when the upper voltage limit of the fuel cell stack is limited, there is a limit in an output of the high-voltage battery that assists the output of the fuel cell, and thus there is a limit in controlling the lower voltage limit of the fuel cell stack. In other words it may thus he difficult to adjust the operation voltage of the fuel cell slack, and thus there is a problem in terms of a high frequency at which the fuel cell stack is exposed to a high voltage. Therefore, research and development is being conducted regarding a fuel cell-battery hybrid type device having a high-voltage battery with high capacitance for a commercial vehicle such as a bus a truck, or a train, which requires high durability of a fuel cell stack and has a low limit in space, weight, or the like of a high-voltage battery, compared with a general passenger vehicle.

The matters disclosed in this section is merely for enhancement of understanding of the general background of the invention and should not be taken as an acknowledgment or any form of suggestion that the matters form the related art already known to a person skilled in the art.

### SUMMARY

An object of the present disclosure is to provide a system and method of controlling an operation of a fuel cell, for preventing an operation voltage of a fuel cell from being exposed to a high voltage close to an open circuit voltage (OCV) using a high-voltage battery with high capacitance.

According to an exemplary embodiment of the present disclosure, an operation control system of a fuel cell may include a fuel cell stack, a motor connected to the fuel cell stack via a main bus end to receive power, a booster disposed between a load and the fuel cell stack of the main bus end to adjust an output voltage of the fuel cell stack, a high-voltage battery connected between a load and the booster of the main bus end, a voltage sensor connected between the booster and the fuel cell stack of the main bus end to measure an output voltage of the fuel cell stack, and a voltage controller configured to set an upper or lower voltage limit of the fuel cell stack based on a state of the fuel cell stack or the high-voltage battery and to operate the booster to maintain the output voltage of the fuel cell stack, measured by the voltage sensor, at the set upper voltage limit or less or at the set lower voltage limit or greater.

The voltage controller may be configured to operate the booster to charge the high-voltage battery while increasing output current of the fuel cell stack when the output voltage of the fuel cell stack is equal to or greater than the set upper voltage limit. The voltage controller may also be configured to operate the booster to discharge the high-voltage battery while maintaining the output voltage of the fuel cell stack when the output voltage of the fuel cell stack is equal to or less than the set lower voltage limit.

The voltage controller may be configured to set a first voltage and a second voltage, which are respectively preset to a maximum voltage and a minimum voltage of an operation voltage range in which durability of the fuel cell stack is optimized, to the upper voltage limit and the lower voltage limit, respectively, in a state in which the fuel cell stack generates power normally. Additionally, the voltage controller may be configured to set the lower voltage limit to a third voltage, which is less than the second voltage and is preset to an allowable minimum voltage of the fuel cell stack, when a temperature of the fuel cell stack is estimated to a preset temperature or less.

When a sum of power output from the fuel cell stack and dischargeable powder of the high-voltage battery is less than power required by the motor and when the output voltage is the second voltage, the voltage controller may be configured to set the lower voltage limit to a third voltage, which is less than the second voltage and is preset to an allowable minimum voltage of the fuel cell stack. When the fuel cell stack enters a fuel cell (FC) stop mode, the voltage controller may be configured to set a first voltage, which is preset to a maximum voltage of a voltage range in which durability of the fuel cell stack is optimized, to the upper voltage limit, and may be configured to set a third voltage, which is preset to an allowable minimum voltage of the fuel cell stack, to the lower voltage limit. The voltage controller may be configured to stop adjustment of a voltage of the fuel cell stack using the booster when the voltage of the fuel cell stack is reduced to the third voltage or less.

The operation control system of the fuel cell may further include a relay disposed between the booster and the fuel cell stack of the main bus end, and a relay controller configured to turn the relay on or off. The relay controller may further be configured to block the relay when the fuel cell stack enters a fuel cell (FC) stop mode and the voltage of the fuel cell stack is reduced to the third voltage or less.

When the fuel cell stack is released from a fuel cell (FC) stop mode, the voltage controller may be configured to set a fourth voltage, which is preset to a maximum voltage for durability of the fuel cell stack, to the upper voltage limit. Maximum dischargeable power of the high-voltage battery may be about 70% or greater of maximum power to be consumed by the motor. Maximum chargeable power of the high-voltage battery may be about 70% or greater of maximum power to be output from the fuel cell stack.

According to another exemplary embodiment of the present disclosure, an operation control method of a fuel cell may include determining a state of a fuel cell stack or a high-voltage battery, setting an upper or lower voltage limit of the fuel cell stack based on the determined state of the fuel cell stack or the high-voltage battery, and operating a booster disposed at a main bus end for connection between the fuel cell stack and a motor to maintain an output voltage of the fuel cell stack, at the set upper voltage limit or less or the set lower voltage limit or greater.

In response to determining that the fuel cell stack is in a state in which power is normally generated, the setting of the upper voltage limit or the lower voltage limit may include setting a first voltage and a second voltage, which are respectively preset to a maximum voltage and a minimum voltage of an operation voltage range in which durability of the fuel cell stack is optimized, to the upper voltage limit and the lower voltage limit, respectively. Additionally, in response to determining that a temperature of the fuel cell stack is equal to or less than a preset temperature, the setting of the upper voltage limit or the lower voltage limit may include setting the lower voltage limit to a third voltage, which is less than the second voltage and is preset to an allowable minimum voltage of the fuel cell stack.

When a sum of power output from the fuel cell stack and dischargeable power of the high-voltage battery is less than power required by the motor in a state in which the output voltage is the second voltage, the setting of the upper voltage limit or the lower voltage limit may include setting the lower voltage limit to a third voltage, which is less than the second voltage and is preset to an allowable minimum voltage of the fuel cell stack. In response to determining that the fuel cell stack enters a fuel cell (FC) stop mode, the setting of the upper voltage limit or the lower voltage limit may include setting a first voltage, which is preset to a maximum voltage of a voltage range in which durability of the fuel cell stack is optimized, to the upper voltage limit, and setting a third voltage, which is preset to an allowable minimum voltage of the fuel cell stack, to the lower voltage limit.

Further, the operation of the booster may include stopping adjustment of a voltage of the fuel cell stack using the booster when the voltage of the fuel cell stack is reduced to the third voltage or less. In response to determining that the fuel cell stack is released from an FC stop mode, the setting of the upper voltage limit or the lower voltage limit may include setting a fourth voltage, which is preset to a maximum voltage for durability of the fuel cell stack, to the upper voltage limit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a performance reduction rate and a platinum (Pt) charge quantity reduction rate depending on an operating voltage range of a cell included in a fuel cell stack according to an exemplary embodiment of the present disclosure;

FIG. 2 is a diagram showing the configuration of an operation control system of a fuel cell according to an exemplary embodiment of the present disclosure;

FIG. 3 is a diagram showing upper and lower voltage limits corresponding to the state of a fuel cell stack or a high-voltage battery according to an exemplary embodiment of the present disclosure; and

FIG. 4 is a flowchart of an operation control method of a fuel cell according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other titan petroleum). As referred to herein, a hybrid vehicle is a vehicle that has two or more sources of power, for example both gasoline-powered and electric-powered vehicles.

Although exemplary embodiment is described us using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer loadable media on a computer readable medium containing executable program instructions executed by a processor, controller/control unit or the like. Examples of the computer readable mediums include, but arc not limited to, ROM, RAM, compact disc (CD-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” arc intended to include die plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided heroin arc modified by the term “about.”

In exemplary embodiments of the present disclosure disclosed in the specification, specific structural and functional descriptions arc merely illustrated for the purpose of illustrating embodiments of the invention and exemplary embodiments of the present disclosure may be embodied in many forms and are not limited to the exemplary embodiments set forth heroin. Exemplary embodiments of the present disclosure may be variously changed and embodied in various forms, in which illustrative embodiments of the invention arc shown. However, exemplary embodiments of the present disclosure should not be construed as being limited to the embodiments set forth herein and any changes, equivalents or alternatives which are within the spirit and scope of the present disclosure should be understood as falling within the scope of the invention.

It will be understood that although the terms first, second, third etc. may be used herein to describe various elements, these elements should not be limited by these terms. These terms are only used to distinguish one element from another element. For example, a first element may be termed a second element and a second element may be termed a first element without departing from the teachings of the present disclosure. It will be understood that when an element, such as a layer, a region, or a substrate, is referred to as being “on”, “connected to” or “coupled to” another element, it may be directly on, connected or coupled to the other clement or intervening elements may be present. In contrast, when an element is referred to as being “directly on,” “directly connected to” or “directly coupled to” another element or layer, there arc no intervening elements or layers present. Other words used to describe the relationship between elements or layers should be interpreted in a like fashion, e.g., “between,” versus “directly between,” “adjacent,” versus “directly adjacent,” etc. The terms used in the present specification are used for explaining a specific exemplary embodiment, not limiting the present inventive concept.

Unless otherwise defined, all terms including technical and scientific terms used herein have the same meaning as commonly understood by one of ordinary skill in the art to which this inventive concept pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Reference will now be made in detail to the exemplary embodiments, examples of which are illustrated in the accompanying drawings. In the drawings the same reference numerals in the drawings denote the same element.

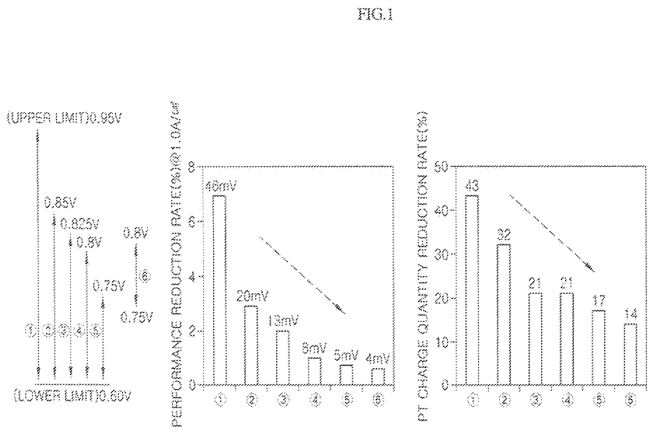

FIG. 1 is a diagram showing a performance reduction rate and a platinum (Pt) charge quantity reduction rate depending on an operating voltage range of a cell included in a fuel cell stack. Referring to FIG. 1, in general, the fuel cell stack is formed by stacking a plurality of unit cells in series. The performance reduction rate and the Pt charge quantity reduction rate, which are characteristics of a catalyst included in a membrane electrode assembly (MEA), may be changed based on the operating voltage range between upper and lower voltage limits of the cell included in the fuel cell stack.

In particular, as seen from an operating voltage range \textcircled{1} or the first range) between about 0.95 V and 0.6 V, which corresponds to when upper and lower voltage limits of a cell voltage are not adjusted separately, the performance reduction rate and the Pt charge quantity reduction rate are high. As seen from an operating voltage range \textcircled{2} or the second range) between about 0.85 V and 0.6 V. which corresponds to the operating voltage range of a general fuel cell vehicle, the performance reduction rate is reduced by half or less.

As seen from operating voltage ranges \textcircled{1}, \textcircled{2}, \textcircled{3}, \textcircled{4}, and \textcircled{5} or the first through fifth range), when the upper voltage limit is gradually reduced, the performance reduction rate may be gradually reduced. However, as shown in FIG. 1, compared with the operating voltage ranges \textcircled{4} and \textcircled{5}, the performance reduction rate is changed minimally due to the reduction in the upper voltage limit, and thus, the effect of increasing durability is negligible. However, as seen from the operating voltage ranges \textcircled{4}, \textcircled{1}, and \textcircled{6} , when the lower voltage limit is increased, the performance reduction rate and the Pt charge quantity reduction rate arc reduced. In other words, as seen from the operating voltage range \textcircled{6} between 0.8 V and 0.75 V, durability is the highest

In a fuel cell system according to the related art, it is difficult to restrict the operating voltage of a fuel cell stack due to the limitations of a high-voltage battery. In particular, when the voltage of the fuel cell stack is restricted to an upper voltage limit or less, surplus power generated in the fuel cell stack needs to be charged in the high-voltage battery, and when the voltage of the fuel cell stack is restricted to a lower voltage limit or greater, the power output from the fuel cell stack is restricted, and thus, power needs to be additionally discharged from the high-voltage battery.

However, there is a limit in restricting the voltage of the fuel cell stack due to limitations on the charge and discharge power of a battery and the capacitance of a buttery, and thus, conventionally, there is a problem in that a fuel cell is controlled to be operated with an upper voltage of only 0.85 V. However, a commercial vehicle such as a bus, a truck, or a train requires an operating time period such that a fuel cell stack lasts three to five times as long as that of a passenger vehicle before reaching an end of life (EOL), and thus further ensuring the durability of the fuel cell stack may be particularly required. Since a commercial vehicle has a low limit in a space or a weight of a high-voltage battery compared with a passenger vehicle, a high-voltage battery with high capacitance may be installed in lie commercial vehicle in order to enhance the durability of the fuel cell stack.

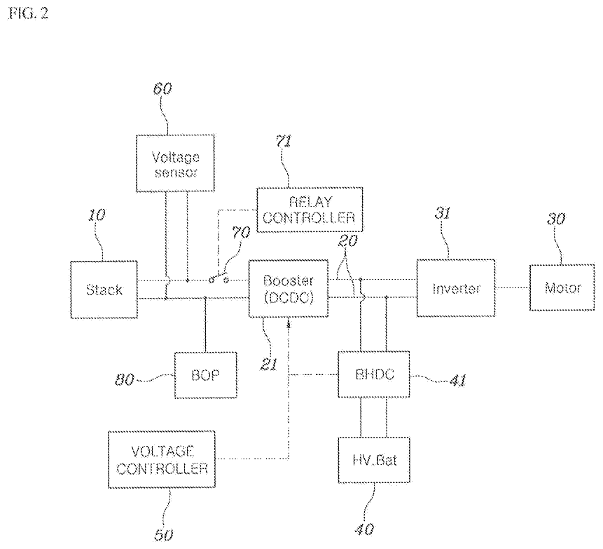

FIG. 2 is a diagram showing tire configuration of an operation control system of a fuel cell according to an exemplary embodiment of the present disclosure. Referring to FIG. 2, the operation control system of the fuel cell according to an exemplary embodiment of the present disclosure may include a fuel cell stack 10, a motor 30 connected to the fuel cell stack 10 via a main bus end 20 to receive power, a booster 21 disposed between a load and the fuel cell stack 10 of the main bus end 20 to adjust the output voltage of the fuel cell stack 10, a high-voltage battery 40 connected between a load and the booster 21 of the main bus end 20, a voltage sensor 60 connected between the booster 21 and the fuel cell stack 10 of the main bus end 20 to measure an output voltage of the fuel cell stack 10, and a voltage controller 50 configured to set an upper or lower voltage limit of the fuel cell stack 10 based on the state of the fuel cell stack 10 or the high-voltage battery 40 and operate the booster 21 to maintain the output voltage of the fuel cell stack 10, measured by the voltage sensor 60, at the set upper voltage limit or less or the lower voltage limit or greater.

Moreover, hydrogen and air may be supplied to the fuel cell stack 10, and electric energy may be generated via a chemical reaction therein. Power generated by the fuel cell stack 10 may be supplied to the motor 30 connected thereto via the main bus end 20. The voltage sensor 60 configured to measure the output voltage of the fuel cell stack 10 may be disposed at the main bus end 20 connected to an output end of the fuel cell stack 10. The booster 21 may correspond to a direct current (DC) booster and may be disposed between the fuel cell stack 10 and the motor 30 to convert and adjust the voltage output from the fuel cell stack 10. The voltage of the fuel cell stack 10 may be increased using the booster 21, and thus, even when the voltage of the fuel cell stack 10 is maintained, it may be possible to operate the fuel cell at a voltage at which an inverter 31 or the like for driving the motor 30 is normally operated.

The motor 30 may be connected to the fuel cell stack 10 and the main bus end 20 to receive power. The main bus end 20 may also be connected to the high-voltage battery 40 to supply power to the motor 30 via discharging. A balance of plant (BOP) 80 may correspond to auxiliary devices for power generation of the fuel cell stack 10 and may be connected to the main bus end 20 to receive power. The BOP 80 may be connected between the fuel cell stack 10 and the booster 21.

As described below, the high-voltage battery 40 may be a high-voltage battery with high capacitance, formed by increasing maximum dischargeable power, maximum chargeable power, and energy capacitance. The high-voltage battery 40 may be charged with power generated by the fuel cell stack 10 or may supplement the power of the fuel cell stack 10 and may be discharged to supply power to the motor 30.

Depending on the voltage range of the high-voltage battery 40, a bidirectional converter 41 configured to adjust an output voltage of a high-voltage battery may be included in the high-voltage battery 40, or may be omitted. The voltage controller 50 may a component within a fuel cell vehicle control unit (FCU), such as an electronic control unit (ECU), or may be a low level controller of the FCU. The voltage controller 50 may be configured to operate the booster 21 to maintain the output voltage of the fuel cell stack 10, measured by the voltage sensor 60, at the set upper voltage limit or less or the lower voltage limit or greater. In particular, as described below, the upper voltage limit and the lower voltage limit may be set based on the state of the fuel cell stack 10 or the high-voltage battery 40.

Accordingly, since the voltage of the fuel cell stack 10 may be adjusted to be within the range of the upper voltage limit or less and the lower voltage limit or greater using the booster 21, the operating voltage range of the fuel cell stack 10 may be restricted to minimize a change in a physical condition such as a temperature or pressure of the fuel cell stack 10, and the fuel cell stack 10 may be prevented from being exposed to high potential to thus prevent degradation of a catalyst, thereby achieving an effect of enhancing the durability of the fuel cell stack 10.

In particular, the voltage controller 50 may be configured to operate the booster 21 to charge the high-voltage battery 40 while increasing the output current of the fuel cell stack 10 when the output voltage of the fuel cell stack 10 is equal to or greater than the set upper voltage limit. In other words, when the power required to be output from the fuel cell stack 10 is reduced and the output voltage of the fuel cell stack 10 is increased, the output voltage of the fuel cell stack 10 may be prevented from being increased, using the booster 21, and thus, output current of the fuel cell stack 10 may be generated to charge the high-voltage battery 40.

On the other hand, the voltage controller 50 may be configured to operate the booster 21 to discharge the high-voltage battery 40 while maintaining the output voltage of the fuel cell stack 10 when the output voltage of the fuel cell stack 10 is equal to or less than the set lower voltage limit. In other words, when the power required to be output from the fuel cell stack 10 is increased and the output voltage of the fuel cell stack 10 is reduced, the output voltage of the fuel cell stack 10 may be prevailed from being reduced, using the booster 21, and thus the power required by the motor 30 may be discharged from the high-voltage battery 40 and may be supplied to the motor 30.

Accordingly, the fuel cell may be operated to prevent the operating voltage range of the fuel cell stack 10 from being beyond or outside of the range between the upper and lower voltage limits. Thus, chargeable power of the high-voltage battery 40 needs to be at a level of excess power of the fuel cell stack 10, and dischargeable power of the high-voltage battery 40 needs to be at a level of insufficient power for the power required by the motor 30 due to limitations of the lower voltage limit of the fuel cell stack 10. In addition, stored electric energy needs to be sufficient to continuously perform such charging and discharging for a substantial period of time.

In particular, the maximum dischargeable power of the high-voltage battery 40 may be about 70% or greater of the maximum power to be consumed by the motor 30. In other words, the high-voltage battery 40 may be discharged with about 70% or greater of the maximum power, which is the maximum value of power consumed by the motor 30. Accordingly, since the output voltage of the fuel cell stack 10 may be prevented from being decreased to the lower voltage limit or less, the high-voltage battery 40 may be configured to supply power to sufficiently compensate for insufficient power for power required by the motor 30, which is output from the fuel cell stack 10.

The maximum chargeable power of the high-voltage battery 40 may be about 70% or greater of the maximum power to be output by the fuel cell stack 10. Since the output voltage of the fuel cell stack 10 may be prevented from being increased to the upper voltage limit or greater, excess power, among the power output from the fuel cell stack 10, may be charged in the high-voltage battery 40. In addition, the energy capacitance of the high-voltage battery 40 may be equal to or greater than electric energy of the motor 30, which is required to drive a vehicle for about 20 km. In other words, maximum dischargeable electric energy from the state in which the high-voltage battery 40 is completely charged to the state in which the high-voltage battery 40 is completely discharged may be used to drive the motor 30 using only the high-voltage battery 40 to drive a fuel cell vehicle for an average of about 20 km or greater. The electric energy of the motor 30 required to drive a vehicle for about 20 km may be calculated based on average fuel efficiency (fuel cost). Accordingly, the high-voltage battery 40 may maintain charge or discharge for a substantial period of lime according to control at an upper or lower voltage limit of the fuel cell stack 10.

The operation control system of the fuel cell may further include a relay 70 disposed between the booster 21 and the fuel cell stack 10 of the main bus end 20, and a relay controller 71 configured to turn the relay 70 on or off. The relay controller 71 may be configured to block the relay 70 when the fuel cell stack 10 enters a fud cell (FC) stop mode and adjustment of the voltage of the fuel cell stack 10 is not required.

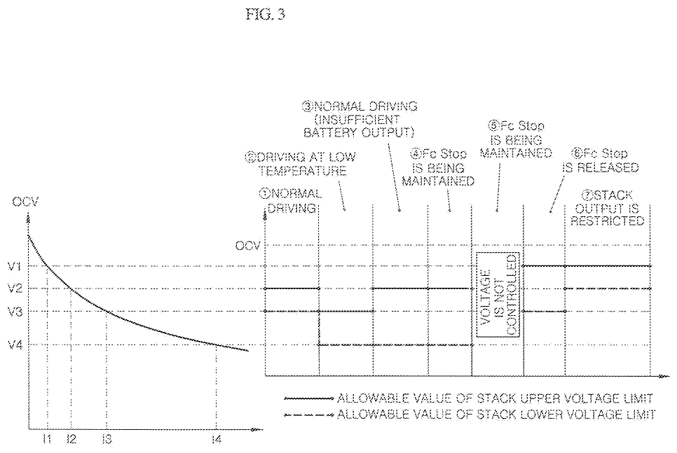

FIG. 3 is a diagram showing upper and lower voltage limits corresponding to the state of the fuel cell stack 10 or the high-voltage battery 40 according to an exemplary embodiment of the present disclosure. Further referring to FIG. 3, the voltage controller 50 may be configured to set an upper or lower voltage limit of the fuel cell stack 10 based on the state of the fuel cell stack 10 or the high-voltage battery 40. The relationship between the output voltage and output current of tire fuel cell stack 10 corresponds to the performance curve shown in FIG. 3, and power (energy) output from a fuel cell is a product of the output voltage and the output current. The power (energy) output from the fuel cell may be varied as the output voltage is varied (I1*V1, I2*V2, I3*V3, I4*V4).

In particular, when the fuel cell stack 10 generates power normally, the voltage controller 50 may be configured to set a first voltage V2 and a second voltage V3, which are respectively preset to a maximum voltage and a minimum voltage of an operating voltage range, in which the durability of the fuel cell stack 10 may be optimized, to the upper voltage limit and the lower voltage limit, respectively. In other words, when the fuel cell stack 10 is in a normal power generation state and chargeable and dischargeable power of the high-voltage battery 40 are within normal ranges, the booster 21 may be operated to operate tire fuel cell stack 10 between the first voltage V2 and the second voltage V3, which is preset to an operating voltage range within which the durability of the fuel cell stack 10 may be optimized. Here, the normal power generation state means a state in which the fuel cell stack is driven to generate to follow the power required for the fuel cell stack, and thereby a state in which power generation of the fuel cell stack is not stopped or restricted by a separate condition (temperature, deterioration, etc.).

The first voltage V2 may be at a level of about 0.8 V based on the voltage of a unit cell, which is an optimized maximum voltage in terms of the durability of the fuel cell stack 10. The second voltage V3 may be at a level of about 0.75 V based on the voltage of a unit cell as a minimum voltage of a preset period in such a way that a physical condition is varied minimally in terms of the durability of the fuel cell stack 10. Accordingly, when the fuel cell stack 10 is in a normal power generation state, the fuel cell stack 10 may be operated within a narrow operating voltage range to minimize a change in a physical condition of a membrane electrode assembly (MEA), thereby achieving an effect of enhancing durability.

When a temperature of the fuel cell stack 10 is estimated to be a predetermined temperature or less, the voltage controller 50 may be configured to set the lower voltage limit to a third voltage V4, which is lower titan the second voltage V3 and preset to an allowable minimum voltage of the fuel cell stack 10. Similar to a cold starting condition, when a temperature of the fuel cell stack 10 is estimated as a preset temperature or less, the temperature of the fuel cell stack 10 may be determined to require to be increased. The preset temperature may be 0° C. or water freezing temperature. Particularly, when a temperature of a coolant at an outlet of the fuel cell stack 10 is equal to or less than 0° C. the fuel cell stack 10 may be operated to increase a temperature.

When a temperature of the fuel cell stack 10 is increased during an operation of the fuel cell stack 10, the fuel cell stack 10 may be operated to maintain an output voltage of the fuel cell stack 10 to be relatively low to accelerate the temperature increase of the fuel cell stack 10. In particular, when the temperature of the fuel cell stack 10 is increased during an operation of the fuel cell stack 10, output performance of the fuel cell stack 10 may be degraded compared with a normal state, and thus, the lower voltage limit may be set to the third voltage V4 that is less than the second voltage V3.

The third voltage V4 may be an allowable minimum voltage of the fuel cell stack 10 and may be preset in consideration of a rated voltage of the motor 30 that receives power output from the fuel cell stack 10 or other balance of plants (BOPs) 80, which receives power output from the fuel cell stack 10. The third voltage V4 may be a voltage at which power output from the fuel cell stack 10 is a highest and may be at a level of about 0.6 V based on the voltage of a unit cell.

In addition, when the temperature of the fuel cell stack 10 is increased during an operation of the fuel cell stack 10, the voltage controller 50 may be configured to set the upper voltage limit of the fuel cell stack 10 to the second voltage V3. In other words, the upper voltage limit of the fuel cell stack 10 may also be decreased to increase thermal energy generated from the fuel cell stack 10. Accordingly, the temperature increase of the fuel cell stack 10 may be accelerated and power generated while the temperature of the fuel cell stack 10 is increased during an operation of the fuel cell stack 10 may be charged in the high-voltage battery 40, thereby achieving an effect for a temperature increase without energy loss.

When the sum of power output from the fuel cell stack 10 and dischargeable power of the high-voltage battery 40 is less than the power required by the motor 30 and when the output voltage is the second voltage V3, the voltage controller 50 may he configured to set the lower voltage limit to the third voltage V4, which is less than the second voltage V3 and preset to an allowable minimum voltage of the fuel cell stack 10. In particular, the fuel cell stack 10 is in a normal power generation state, but when dischargeable power of the high-voltage battery 40 is decreased due to consumption of electric energy stored in the high-voltage battery 40, or overheating or cooling of the high-voltage battery 40, the lower voltage limit may be decreased.

When the sum of power output from the fuel cell stack 10 and the dischargeable power of the high-voltage battery 40 is less than the power required by the motor 30 and when the dischargeable power of the high-voltage battery 40 is reduced and the output voltage is the second voltage V3, the voltage controller 50 may be configured to set the lower voltage limit to the third voltage V4, which is preset to an allowable minimum voltage of the fuel cell stack 10. Accordingly, the voltage of the fuel cell stack 10 may be decreased to achieve an effect of satisfying the power required by the motor 30.

When the fuel cell stack 10 enters a FC stop mode, the voltage controller 50 may be configured to set the first voltage V2, which is preset to a maximum voltage of a voltage range in which the durability of the fuel cell stack 10 is maximized, to the upper voltage limit, and maybe configured to set the third voltage V4, which is preset to the allowable minimum voltage of the fuel cell stack 10, to the lower voltage limit. In the FC stop mode of the fuel cell stack 10, when the state of charge (SOC) of the high-voltage battery 40 is equal to or greater than a preset SOC and the power required by the motor 30 is equal to or less than the dischargeable power of the high-voltage battery 40, power generation of the fuel cell stack 10 may stopped and the motor 30 may be driven only by the power discharged from the high-voltage battery 40. In the FC stop mode of the fuel cell stack 10, air supply to the fuel cell stack 10 may be blocked and concentration adjustment of hydrogen may be stopped.

In the early stage in which the fuel cell stack 10 enters the FC stop mode, the hydrogen and oxygen already supplied to the fuel cell stack 10 remains within the stack, and thus, the output voltage of the fuel cell stack 10 requires continuous adjustment. Particularly, the current state is the state in which the voltage of the fuel cell stack 10 is decreased, and thus, the lower voltage limit may be set to the third voltage V4, which is preset to the allowable minimum voltage of the fuel cell stack 10.

When the voltage of the fuel cell stack 10 is reduced to the third voltage V4 or less, the voltage controller 50 may be configured to stop adjustment of the voltage of the fuel cell stack 10 using the booster 21. In particular, the operation control system of the fuel cell may further include the relay 70 disposed between the booster 21 and the fuel cell stack 10 of the main bus end 20, and the relay controller 71 configured to turn the relay 70 on or off. The relay controller 71 may be configured to block the relay 70 when the fuel cell stack 10 enters a FC stop mode and the voltage of the fuel cell stack 10 is reduced to the third voltage V4 or less.

In other words, when the fuel cell stack 10 enters the FC stop mode and the output voltage is reduced to the third voltage V4 or less, oxygen remaining in the fuel cell stack 10 may be entirely consumed and air may not be supplied any longer, and thus, power generation of the fuel cell stack 10 may be stopped. The relay 70 may be operated to interrupt the connection between the fuel cell stack 10 and the booster 21 and thus, the voltage of the fuel cell stack 10 may be prevented from increasing to the open circuit voltage (OCV).

The voltage of the fuel cell stack 10 may be consumed by charging the high-voltage battery 40, and then, the relay 70 may be blocked. When the relay controller 71 blocks the relay 70 while a significant amount of current flows in the main bus end 20, the relay 70 may be melting-adhered and be damaged. Accordingly, when the voltage of the fuel cell stack 10 is reduced to the third voltage V4 or less and the current flowing in the main bus end 20 is reduced to a stable range or lower, the relay controller 71 may be configured to block the relay 70.

When the fuel cell stack 10 is released from the FC stop mode, the voltage controller 50 may be configured to set a fourth voltage V1, which is preset to a maximum voltage for the durability of the fuel cell stack 10, to the upper voltage limit. When the electric energy charged in the high-voltage battery 40 is again reduced to restart power generation by the fuel cell stack 10, sufficient concentration of hydrogen supplied to the fuel cell stack 10 needs to be ensured to generate power normally in the fuel cell stack 10. In other words, when it is difficult to immediately permit a load of the motor 30, on excessive amount of current may be prevented from being generated while preventing the fuel cell stack 10 from being exposed to the OCV. Accordingly, the upper voltage limit of the fuel cell stack 10 may be increased to the fourth voltage V1 to alleviate the problem. The fourth voltage V1 may be at a level of about 0.85 V based on the voltage of a unit cell, which is an allowable maximum voltage, to prevent the durability of the fuel cell stack 10 from being degraded.

Accordingly, until live fuel cell stack 10 is restored to a normal power generation state, the fuel cell stack 10 may be operated to prevent the load of the motor 30 from being excessive and to prevent the fuel cell stack 10 from being exposed to a high voltage close to OCV. When an internal suite (e.g., output voltage, hydrogen concentration, etc.) of the fuel cell stack 10 is normally restored, the fuel cell stack 10 may be restored to a normal driving mode.

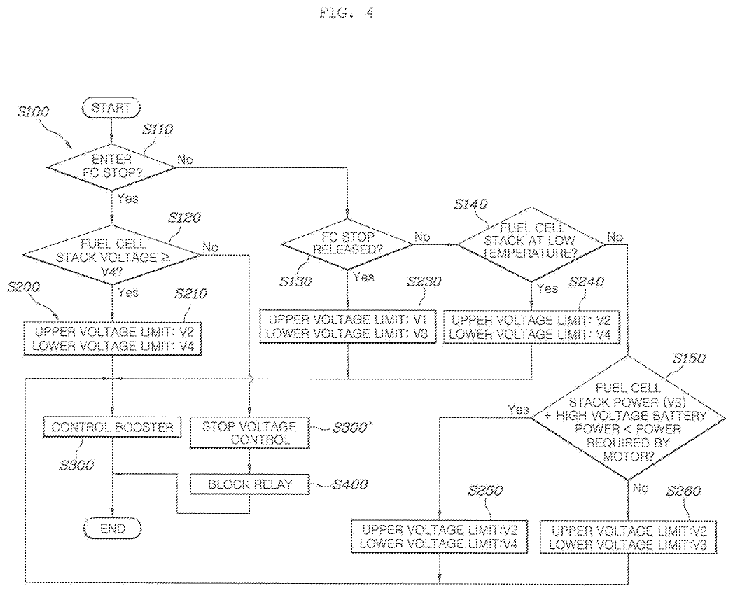

FIG. 4 is a flowchart of an operation control method of a fuel cell according to an exemplary embodiment of the present disclosure. The method described herein below may be executed by a controller having a processor and memory. The controller may be specifically programmed to execute the method. Referring to FIG. 4, the operation control method of the fuel cell may include determining the state of a fuel cell stack or a high-voltage battery (S100), setting an upper or lower voltage limit of the fuel cell stack based on the determined state of the fuel cell stack or the high-voltage battery (S200), and operating a booster disposed at a main bus end for connection between the fuel cell stack and a motor to maintain an output voltage of the fuel cell stack to the set upper voltage limit or less or the lower voltage limit or greater (S300).

In the determining of the state of the stack (S100), in response to determining the state to be the state in which the fuel cell stack generates power normally, a first voltage and a second voltage, which arc respectively preset to a maximum voltage and a minimum voltage of a voltage period in which the durability of the fuel cell stack is optimized, may be set to the upper voltage limit and the lower voltage limit, respectively (S260) in the selling of the upper voltage limit or the lower voltage limit (S200).

In the determining of the state of the stack (S100), in response to determining that a temperature of the fuel cell stack is equal to or less than a preset temperature (S140), the lower voltage limit may be set to a third voltage, which is less than the second voltage and is preset to an allowable minimum voltage of the fuel cell stack (S240) in the setting of the upper voltage limit or the lower voltage limit (S200). Additionally, when the sum of power output from the fuel cell stack and dischargeable power of the high-voltage battery is less than power required by a motor in the state in which the output voltage is the second voltage (S150), the lower voltage limit may be set to the third voltage, which is less than the second voltage and is preset to an allowable minimum voltage of the fuel cell stack (S250) in the setting of the upper voltage limit or the lower voltage limit (S200).

In response to determining that the fuel cell stack enters a fuel cell (PC) stop mode (S110), the first voltage that is preset to a maximum voltage of a voltage range in which the durability of the fuel cell stack is optimized, may be set to the upper voltage limit, and the third voltage, which is preset to an allowable minimum voltage of the fuel cell stack, may be set to the lower voltage limit (S210) in lire setting of the upper voltage limit or the lower voltage limit (S200).

Further, in the operating of the booster (S300), when the voltage of the fuel cell stack is reduced to the third voltage or less (S120), adjustment of the voltage of the fuel cell stack using the booster may be stopped (S300′). Additionally, when control of the voltage of the fuel cell stack is stopped (S300′), the method may further include blocking a relay disposed at a main bus end between the fuel cell stack and the booster (S400) after the operating of the booster (S300). In the determining of the state of the stack (S100), in response to determining that the fuel cell stack is released from a FC stop mode (S130), a fourth voltage, which is preset to an maximum voltage for the durability of the fuel cell stack, may be set to the upper voltage limit (S230) in the setting of the upper voltage limit or the lower voltage limit (S200). The lower voltage limit may be set to the third voltage, which is preset to an allowable minimum voltage of the fuel cell stack.

As described above, a system and method of controlling an operation of a fuel cell according to the present disclosure may prevent a fuel cell stack from reaching a high voltage, thereby achieving an effect of substantially increasing the durability of a fuel cell stack. In addition, since an operation voltage range of a fuel cell stack is reduced, a change in a physical condition of the fuel cell stack may be minimized, thereby achieving an effect of enhancing the durability of the fuel cell stack.

Accordingly, the aforementioned exemplary embodiments are exemplary in all aspects and are understood not to be limited. The scope of the present disclosure is defined by the following claims but not the above description and the meaning and scope of the claims and all modifications or modified forms from equivalents thereof are within tire scope of the present disclosure.

1. An operation control system of a fuel cell, comprising:
a fuel cell stack;
a motor connected to the fuel cell stack via a main bus end to receive power,
a booster disposed between a load and the fuel cell stack of the main bus end to adjust an output voltage of the fuel cell stack;
a high-voltage battery connected between a load and the booster of the main bus end;
a voltage sensor connected between the booster and the fuel cell stack of the main bus end to measure an output voltage of the fuel cell stack; and
a voltage controller configured to set an upper or lower voltage limit of the fud cell stack based on a state of the fuel cell stack or the high-voltage battery and to operate the booster to maintain the output voltage of the fuel cell stack, measured by the voltage sensor, at the set upper voltage limit or less or the set lower voltage limit or greater.

2. The operation control system of the fuel cell of claim 1, wherein the voltage controller is configured to operate the booster to charge the high-voltage battery while increasing output current of the fuel cell stack when the output voltage of the fuel cell stack is equal to or greater than the set upper voltage limit.

3. The operation control system of the fuel cell of claim 1, wherein the voltage controller is configured to operate the booster to discharge the high-voltage battery while maintaining the output voltage of the fuel cell stack when the output voltage of the fuel cell stack is equal to or less than the set lower voltage limit.

4. The operation control system of the fuel cell of claim 1, wherein the voltage controller is configured to set a first voltage and a second voltage, which arc respectively preset to a maximum voltage and minimum voltage of an operation voltage range in which durability of the fuel cell stack is optimized, to the upper voltage limit and the lower voltage limit, respectively, in a state in which the fuel cell stack generates power normally.

5. The operation control system of the fuel cell of claim 4, wherein the voltage controller is configured to set the lower voltage limit to a third voltage, which is less than the second voltage and is preset to an allowable minimum voltage of the fuel cell stack, when a temperature of the fuel cell stack is estimated to a preset temperature or less.

6. The operation control system of the fuel cell of claim 4, wherein when a sum of power output from the fuel cell stack and dischargeable power of the high-voltage battery is less than power required by the motor in a state in which the output voltage is the second voltage, the voltage controller is configured to set the lower voltage limit to a third voltage, which is less than the second voltage and is preset to an allowable minimum voltage of the fuel cell stack.

7. The operation control system of the fuel cell of claim 1, wherein when the fuel cell stack enters a fuel cell (FC) stop mode, the voltage controller is configured to set a first voltage, which is preset to a maximum voltage of a voltage range in which durability of the fuel cell stack is optimized, to the upper voltage limit, and set a third voltage, which is preset to an allowable minimum voltage of the fuel cell stack, to the lower voltage limit.

8. The operation control system of the fuel cell of claim 7, wherein the voltage controller is configured to stop adjustment control of a voltage of the fuel cell stack using the booster when the voltage of the fuel cell stack is reduced to the third voltage or less.

9. The operation control system of tire fuel cell of claim 8, further comprising:
a relay disposed between the booster and the fuel cell stack of tire main bus end; and
a relay controller configured to turn the relay on or off,
wherein the relay controller is configured to block the relay when the fuel cell stack enters the FC stop mode and the voltage of the fuel cell stack is reduced to the third voltage or less.

10. The operation control system of the fuel cell of claim 1, wherein when the fuel cell stack is released from a fuel cell (FC) stop mode, the voltage controller is configured to set a fourth voltage, which is preset to a maximum voltage for durability of the fuel cell stack, to the upper voltage limit.

11. The operation control system of the fuel cell of claim 1, wherein maximum dischargeable power of the high-voltage battery is about 70% or greater of maximum power to be consumed by the motor.

12. The operation control system of the fuel cell of claim 1, wherein maximum chargeable power of the high-voltage battery is about 70% or greater of maximum power to be output from the fuel cell stack.

13. An operation control method of a fuel cell, comprising:
determining, by a controller, a state of a fuel cell stack or a high-voltage battery;
setting, by the controller, an upper or lower voltage limit of the fuel cell stack based on the determined stale of the fuel cell stack or the high-voltage battery; and
operating, by the controller, a booster disposed at a main bus end for connection between the fuel cell stack and a motor to maintain an output voltage of the fuel cell stack, at the set upper voltage limit or less or the set lower voltage limit or greater.

14. The method of claim 13, wherein in response to determining that the fuel cell stack is in a state in which power is normally generated, lire setting of the upper voltage limit or the lower voltage limit includes:
setting, by the controller, a first voltage and a second voltage, which arc respectively preset to a maximum voltage and a minimum voltage of an operation voltage range in which durability of the fuel cell stack is optimized, to the upper voltage limit and the lower voltage limit, respectively.

15. The method of claim 14, wherein in response to determining that a temperature of the fuel cell stack is equal to or less than a preset temperature, the setting of the upper voltage limit or the lower voltage limit includes:
setting, by the controller, the lower voltage limit to a third voltage, which is less than the second voltage and is preset to an allowable minimum voltage of the fuel cell stack.

16. The method of claim 14, wherein when a sum of power output from the fuel cell stack and dischargeable power of the high-voltage battery is less than power required by the motor in a state in which the output voltage is the second voltage, the setting of the upper voltage limit or the lower voltage limit includes:
setting, by the controller, the lower voltage limit to a third voltage, which is less than the second voltage and is preset to an allowable minimum voltage of the fuel cell stack.

17. The method of claim 13, wherein in response to determining that the fuel cell stack enters a fuel cell (FC) stop mode in the determining of the state, the setting of the upper voltage limit or the lower voltage limit includes:
setting, by the controller, a first voltage, which is preset to a maximum voltage of a voltage range in which durability of the fuel cell stack is optimized, to the upper voltage limit; and
setting, by the controller, a third voltage, which is preset to an allowable minimum voltage of the fuel cell stack, to the lower voltage limit.

18. The method of claim 17, wherein the operating of the booster includes:
stopping, by the controller, adjustment of a voltage of the fuel cell stack using the booster when the voltage of the fuel cell stack is reduced to the third voltage or less.

19. The method of claim 13, wherein in response to determining that the fuel cell stack is released from a fuel cell stop mode in the determining of the state, the setting of the upper voltage limit or the lower voltage limit includes:
setting, by the controller, a fourth voltage, which is preset to a maximum voltage for durability of the fuel cell stack, to the upper voltage limit.
